(19) United States
(12) Patent Application Publication
(10) Pub. No.: US 2026/0095768 A1
(43) Pub. Date: Apr. 2, 2026

(54) MULTI-OPERATOR CORE SASE FOR 5G SASE

(71) Applicant: Palo Alto Networks, Inc., Santa Clara, CA (US)

(72) Inventors: Yogesh Vijay Ranade, San Jose, CA (US); Anand Oswal, Pleasanton, CA (US)

(21) Appl. No.: 19/217,567

(22) Filed: May 23, 2025

Related U.S. Application Data
(63) Continuation-in-part of application No. 18/756,592, filed on Jun. 27, 2024.
(63) Continuation-in-part of application No. 18/756,621, filed on Jun. 27, 2024.
(60) Provisional application No. 63/634,210, filed on Apr. 15, 2024.
(60) Provisional application No. 63/634,219, filed on Apr. 15, 2024.
(60) Provisional application No. 63/634,210, filed on Apr. 15, 2024.
(60) Provisional application No. 63/634,219, filed on Apr. 15, 2024.
(60) Provisional application No. 63/661,476, filed on Jun. 18, 2024.
(60) Provisional application No. 63/661,476, filed on Jun. 18, 2024.
(60) Provisional application No. 63/661,476, filed on Jun. 18, 2024.

(51) Int. Cl. H04W 12/088; H04W 12/037; H04W 12/121; H04W 12/72

(52) U.S. Cl. CPC H04W 12/088; H04W 12/037; H04W 12/121; H04W 12/72

(57) ABSTRACT

Techniques for providing multi-operator core SASE solutions (e.g., for 5G SASE) are disclosed. In some embodiments, a system, a process, and/or a computer program product for providing multi-operator core SASE solutions for 5G SASE includes receiving mobile network traffic, at a Secure Access Service Edge (SASE) cloud network, via a service provider interconnect between a plurality of mobile service provider networks and the SASE cloud network; monitoring the mobile network traffic at the SASE cloud network from the plurality of mobile service provider networks for a tenant of the SASE cloud network provider; enforcing a security policy based on one or more parameters associated with the mobile network traffic, wherein the security policy is associated with the tenant of the SASE cloud network provider; and forwarding the secured data plane traffic from the SASE cloud network to its original destination if allowed by the security policy, and block or drop the data plane traffic from the SASE cloud network if not allowed by the security policy.

### CROSS REFERENCE TO OTHER APPLICATIONS

This application is a continuation in part of U.S. patent application Ser. No. 18/756,592 entitled SECURE ACCESS SERVICE EDGE FOR MOBILE NETWORKS filed Jun. 27, 2024, which claims priority to U.S. Provisional Patent Application No. 63/634,210 entitled SECURE ACCESS SERVICE EDGE FOR MOBILE NETWORKS filed Apr. 15, 2024, U.S. Provisional Patent Application No. 63/634,219 entitled SECURE ACCESS SERVICE EDGE FOR MOBILE NETWORKS filed Apr. 15, 2024, and U.S. Provisional Patent Application No. 63/661,476 entitled SECURE ACCESS SERVICE EDGE SOLUTION FOR PROVIDING ENHANCED SECURITY FOR MOBILE NETWORKS filed Jun. 18, 2024, all of which are incorporated herein by reference for all purposes.

This application is also a continuation in part of U.S. patent application Ser. No. 18/756,621 entitled SECURE ACCESS SERVICE EDGE FOR MOBILE NETWORKS filed Jun. 27, 2024, which claims priority to U.S. Provisional Patent Application No. 63/634,210 entitled SECURE ACCESS SERVICE EDGE FOR MOBILE NETWORKS filed Apr. 15, 2024, U.S. Provisional Patent Application No. 63/634,219 entitled SECURE ACCESS SERVICE EDGE FOR MOBILE NETWORKS filed Apr. 15, 2024, and U.S. Provisional Patent Application No. 63/661,476 entitled SECURE ACCESS SERVICE EDGE SOLUTION FOR PROVIDING ENHANCED SECURITY FOR MOBILE NETWORKS filed Jun. 18, 2024, all of which are incorporated herein by reference for all purposes.

This application also claims priority to U.S. Provisional Patent Application No. 63/661,476 entitled SECURE ACCESS SERVICE EDGE SOLUTION FOR PROVIDING ENHANCED SECURITY FOR MOBILE NETWORKS filed Jun. 18, 2024, which is incorporated herein by reference for all purposes.

### BACKGROUND OF THE INVENTION

A firewall generally protects networks from unauthorized access while permitting authorized communications to pass through the firewall. A firewall is typically a device or a set of devices, or software executed on a device, such as a computer, that provides a firewall function for network access. For example, firewalls can be integrated into operating systems of devices (e.g., computers, smart phones, or other types of network communication capable devices). Firewalls can also be integrated into or executed as software on computer servers, gateways, network/routing devices (e.g., network routers), or data appliances (e.g., security appliances or other types of special purpose devices).

Firewalls typically deny or permit network transmission based on a set of rules. These sets of rules are often referred to as policies. For example, a firewall can filter inbound traffic by applying a set of rules or policies. A firewall can also filter outbound traffic by applying a set of rules or policies. Firewalls can also be capable of performing basic routing functions.

### BRIEF DESCRIPTION OF THE DRAWINGS

Various embodiments of the invention are disclosed in the following detailed description and the accompanying drawings.

FIG. 1 is a system diagram of an architecture for providing multi-operator core SASE solutions for 5G SASE in accordance with some embodiments.

FIG. 2 is another system diagram of an architecture for providing multi-operator core SASE solutions for 5G SASE in accordance with some embodiments.

FIG. 3 is an example table for cellular network details for security policy enforcement for providing multi-operator core SASE solutions for 5G SASE in accordance with some embodiments.

FIG. 4 is a flow diagram of a process for providing multi-operator core SASE solutions for 5G SASE in accordance with some embodiments.

FIG. 5 is another flow diagram of a process for providing multi-operator core SASE solutions for 5G SASE in accordance with some embodiments.

FIG. 6 is another flow diagram of a process for providing multi-operator core SASE solutions for 5G SASE in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Security service providers also offer various commercially available cloud-based security solutions including various firewall, VPN, including Secure Access Service Edge (SASE), and various other security related services. For example, some security service providers have their own data centers in multiple geographies across the world to provide their customers such cloud-based security solutions.

Generally, a secure access service edge (SASE) brings together networking and network security services in a single cloud-based platform. This way, organizations can embrace cloud and mobility while reducing the complexity of dealing with multiple point products as well as saving IT, financial, and human resources.

For example, a SASE solution can generally include networking capabilities that an enterprise already uses. SASE can integrate the following networking features into a cloud-based infrastructure: SD-WAN edge devices, VPN services, and web proxying, which are each further described below.

Software-defined wide area network (SD-WAN) edge devices can provide easier connectivity for branch offices. With SASE, these devices are connected to a cloud-based infrastructure rather than to physical SD-WAN hubs located in other locations. By moving to the cloud, enterprises can eliminate the complexity of managing physical SD-WAN hubs and promote interconnectivity between branch offices.

Virtual private network (VPN) services incorporated by a SASE solution enable enterprises to route traffic through a VPN (e.g., using IPSec tunnels) to the SASE solution, and then to any application in the public or private cloud, delivered via Software as a Service (SaaS), or on the Internet. Traditional VPN was used for remote access to the internal data center, but it is typically not optimized for the current/evolving cloud computing environment.

Web proxying provides an alternate means of securely connecting users to applications by inspecting web-based protocols and traffic. Proxies were typically used for web security enforcement, but due to their inherent security limitations, they are now typically used as an architectural alternative for device traffic that cannot be fully inspected (e.g., personal devices that cannot accept an endpoint agent to force all web and non-web traffic through security inspection). When implemented as part of a SASE solution, proxies can offer organizations with legacy architectures an easier way of adopting the more robust security capabilities SASE has to offer.

In addition, SASE can incorporate the network security service tools enterprises have generally relied upon in prior computing environments. In a comprehensive SASE solution, the following security services can be delivered through a cloud-based infrastructure: Zero Trust Network Access (ZTNA), firewall/security as a service (FWaaS), secure web gateways (SWG), data loss prevention (DLP), and cloud access security broker (CASB), which are each further described below.

Zero Trust Network Access (ZTNA) applies the Zero Trust secure computing approach (e.g., never trust, always verify) to the cloud computing environment. For example, ZTNA can be applied to require that every user authenticate to access the cloud, restricting access and minimizing the risk of, for example, data loss. However, ZTNA solutions based on a software-defined perimeter (SDP) model can lack content inspection capabilities needed for consistent security protection for enterprises. Also, moving to a cloud-based SASE infrastructure can eliminate the complexity of connecting to a gateway. For example, users, devices, and apps can be identified no matter where they connect from, and the below further described ZTNA solutions of protecting applications can be applied across all services, including data loss prevention (DLP) and threat prevention.

Firewall as a service (FWaaS) provides next-generation firewall features in the cloud computing environment (e.g., also referred to herein as the cloud), thereby removing the need for physical hardware at branch and retail locations. For example, SASE solutions can integrate FWaaS into its cloud-based platform, allowing simplified management and deployment.

### Overview Of Techniques For Multi-Operator Core SASE Solutions for 5G SASE

Technical and security challenges with providing security for service provider networks exist. Specifically, technical and security challenges with integration of mobile devices connecting via mobile networks (e.g., 4G, 5G, 6G, and later mobile devices) with Secure Access Service Edge (SASE) solutions exist.

Specifically, in Enterprise computing environments, there generally are users (e.g., users associated with the enterprise, such as employees, contractors, Internet of Things (IoT) devices, etc.) with cellular devices (e.g., 5G SIM devices, IoT devices, etc.) from multiple mobile network service providers (e.g., AT&T, T-Mobile, Verizon, and/or other mobile network service providers, which are also referred to herein as mobile operators).

However, SASE solution providers (e.g., SASE 5G solutions) typically only support 5G connectivity with specific mobile operators (e.g., the mobile operators that the SASE solution provider has partnered and integrated with its SASE solution service).

As such, this results in a problematic coverage gap in the SASE solution provider's capability to facilitate comprehensive zero trust security for their enterprise customers (e.g., 5G powered enterprises) as there may be mobile operators that are not supported by the SASE solution provider but are used by certain enterprise customers.

Below are examples that cannot be adequately addressed given the above-described coverage gap for SASE solution providers due to a lack of support for all potential mobile operators used by one or more enterprise customers.

As a first example, assume that Alice has a mobile device (e.g., 5G mobile device) from T-Mobile, and assume that Bob has a mobile device (e.g., 5G mobile device) from AT&T. If the SASE solution provider has partnered and integrated only with T-Mobile, then the SASE solution provider can provide zero trust security only to Alice's mobile device and not to Bob's mobile device.

As a second example, assume that a global large water and waste management company with sites across multiple countries uses SIMs from different mobile operators in those countries as their infrastructure is connected over 5G cellular services. The global large water and waste management company desires zero trust security for their infrastructure (e.g., meters, sensors, other infrastructure, which includes Internet of Things (IoT) devices) with 5G SIMs for connectivity from multiple mobile operators for their various locations. If the SASE solution provider has not partnered/integrated with each of these multiple mobile operators used by the global large water and waste management company for their various locations, then the SASE solution provider cannot provide a comprehensive zero trust security solution for this enterprise customer.

Thus, what are needed are new and improved solutions for monitoring such network traffic and applying intelligent security for zero trust in mobile network environments using a SASE solution, such as for mobile devices (e.g., UEs) communicating over a plurality of service provider networks (e.g., mobile networks associated with two or more service providers, such as AT&T, T-Mobile, Verizon, etc.).

Accordingly, new and improved techniques for providing multi-operator core SASE solutions (e.g., for 5G SASE) are disclosed.

In some embodiments, a system, a process, and/or a computer program product for providing multi-operator core SASE solutions (e.g., for 5G SASE) includes receiving mobile network traffic, at a Secure Access Service Edge (SASE) cloud network, via a service provider interconnect between a plurality of mobile service provider networks and the SASE cloud network; monitoring the mobile network traffic at the SASE cloud network from the plurality of mobile service provider networks for a tenant of the SASE cloud network provider; enforcing a security policy based on one or more parameters associated with the mobile network traffic, wherein the security policy is associated with the tenant of the SASE cloud network provider; and forwarding the secured data plane traffic from the SASE cloud network to its original destination if allowed by the security policy, and block or drop the data plane traffic from the SASE cloud network if not allowed by the security policy.

In some embodiments, a system, a process, and/or a computer program product for providing multi-operator core SASE solutions (e.g., for 5G SASE) includes receiving, at an SD-WAN device, Wi-Fi traffic for an enterprise network; routing the Wi-Fi traffic to one or more of a plurality of mobile service provider networks based on an enterprise SD-WAN policy; receiving, at a Secure Access Service Edge (SASE) cloud network, mobile network traffic from a plurality of mobile service provider networks via a service provider interconnect; monitoring the mobile network traffic, at the SASE cloud network from the plurality of mobile service provider networks, for a tenant of the SASE cloud network provider; enforcing a security policy based on one or more parameters associated with the mobile network traffic, wherein the security policy is associated with the tenant of the SASE cloud network provider, and wherein the enterprise network is associated with the tenant of the SASE cloud network provider; and forwarding the secured data plane traffic from the SASE cloud network to its original destination if allowed by the security policy, and block or drop the data plane traffic from the SASE cloud network if not allowed by the security policy.

In an example implementation, the service provider interconnect between the plurality of mobile service provider networks and the SASE cloud network is provided using a roaming network provider.

In an example implementation, the SASE cloud network includes a firewall as a service (FWaaS) that is configured with distinct security policies for each of a plurality of tenants of the SASE cloud network provider, and the security policy is selected based on a subscriber identity and an application identifier, and the subscriber identity includes an International Mobile Subscriber Identity (IMSI).

In an example implementation, the SASE cloud network includes a firewall as a service that is configured with distinct security policies for each of a plurality of tenants of the SASE cloud network provider, and the security policy is selected based on a subscriber identity, a unique device identifier, and an application identifier (e.g., the subscriber identity includes an International Mobile Subscriber Identity (IMSI) and/or Mobile Station International Subscriber Directory Number (MSISDN)), and the unique device identifier includes an International Mobile Equipment Identifier (IMEI).

In an example implementation, the mobile network traffic includes data plane traffic, and the security policy is enforced on the data plane traffic associated with a UE based on contextual information associated with the UE to provide secured data plane traffic using the security policy configured per user group and/or per user associated with the tenant of the SASE cloud network provider.

In an example implementation, the mobile network traffic includes data plane traffic, and the plurality of mobile service provider networks includes a 4G mobile core network, a 5G mobile core network, and/or 6G mobile core network, and wherein the data plane traffic from the plurality of mobile service provider networks is secured from and to 4G, 5G, and/or 6G UE devices.

In an example implementation, Internet access is secured from and to 4G, 5G, and/or 6G UE devices, and enterprise data center access is secured from and to 4G, 5G, and/or 6G UE devices.

In an example implementation, the mobile network traffic includes data plane traffic, and selection and the enforcement of the security policy is based on the contextual information associated with a UE and the data plane traffic is correlated with the UE based on a UE Internet Protocol (IP) address.

In an example implementation, the mobile network traffic includes data plane traffic, and a firewall as a service (FWaaS) associated with the SASE cloud network is configured to perform Uniform Resource Link (URL) filtering for the data plane traffic.

In an example implementation, the mobile network traffic includes data plane traffic, and a firewall as a service (FWaaS) associated with the SASE cloud network is configured to perform application Denial of Service (DoS) detection for the data plane traffic.

In an example implementation, the mobile network traffic includes data plane traffic, and a firewall as a service (FWaaS) associated with the SASE cloud network is configured to perform application Denial of Service (DoS) prevention for the data plane traffic.

In an example implementation, each of a plurality of security policies is distinctly selected and enforced for each mobile service provider (MSP) enterprise tenant at the SASE cloud network (e.g., per tenant security policy configuration and enforcement are provided by the SASE cloud network).

In an example implementation, the mobile network traffic includes data plane traffic, and wherein the data plane traffic is encapsulated with meta information, including a subscriber identity and/or a unique device identifier.

In some embodiments, the mobile network traffic includes data plane traffic, and a system, a process, and/or a computer program product for providing multi-operator core SASE solutions (e.g., for 5G SASE) further includes determining the security policy to apply at the SASE cloud network to the data plane traffic based on a subscriber identity and/or a unique device identifier.

For example, the disclosed techniques for providing multi-operator core SASE solutions (e.g., for 5G SASE) include monitoring network traffic and applying intelligent security for zero trust for devices communicating via mobile network environments using a SASE solution, such as for mobile devices (e.g., UEs) connecting to and/or communicating over service provider networks (e.g., mobile networks associated with one or more service providers, such as AT&T, T-Mobile, Verizon, etc.) for applying context-based and/or enhanced security in mobile networks based on subscriber-ID/International Mobile Subscriber Identity (IMSI)/Subscription Permanent Identifier (SUPI), Mobile Station International Subscriber Directory Number (MSISDN), equipment-ID/International Mobile Equipment Identity (IMEI)/Permanent Equipment Identifier (PEI), Network Slice ID/Single Network Slice Selection Assistance Information (S-NSSAI), User Equipment (UE) IP, Access Point Name (APN)/Data Network Name (DNN), and/or Radio Access Technology (RAT) Type information, IP to mobile subscriber traffic mappings, and/or other context-based information to facilitate enhanced security for such mobile devices communicating via mobile networks to access enterprise networks, applications including Software as a Service (SaaS)-based applications or other cloud-based applications/services, and/or other Internet activities, such as will be further described below.

In an example implementation, the disclosed techniques for providing multi-operator core SASE solutions (e.g., for 5G SASE) provide for a seamless integration with such service provider's mobile networks (i.e., two or more distinct service provider mobile networks) without requiring security equipment or software to be located in the service provider's core mobile networks, by using a service provider interconnect between the plurality of mobile service provider networks (e.g., the service provider interconnect can be provided using a roaming network provider), such as will be further described below.

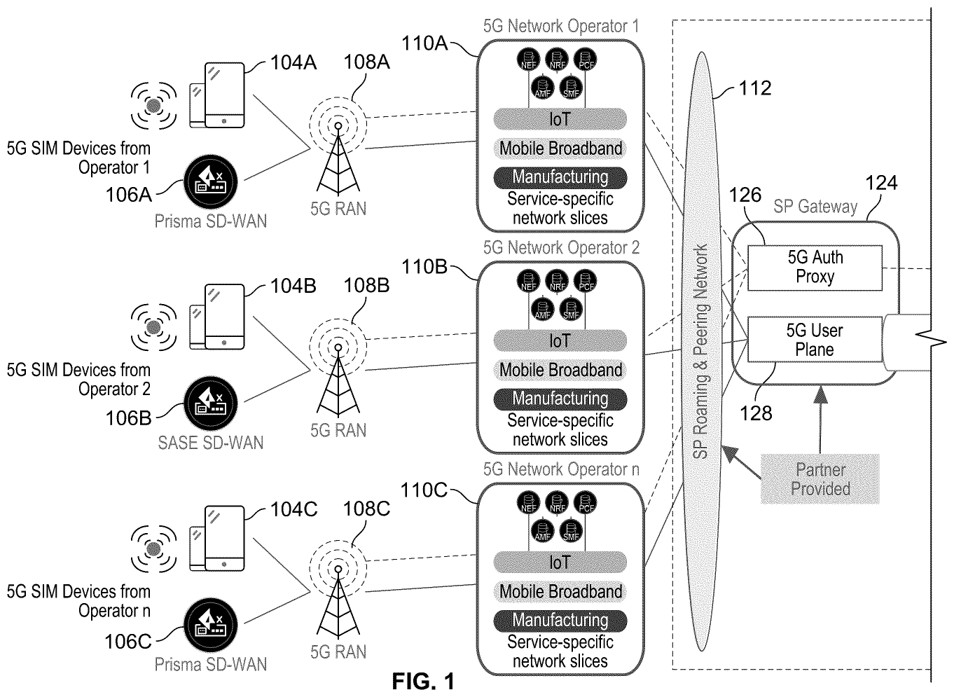

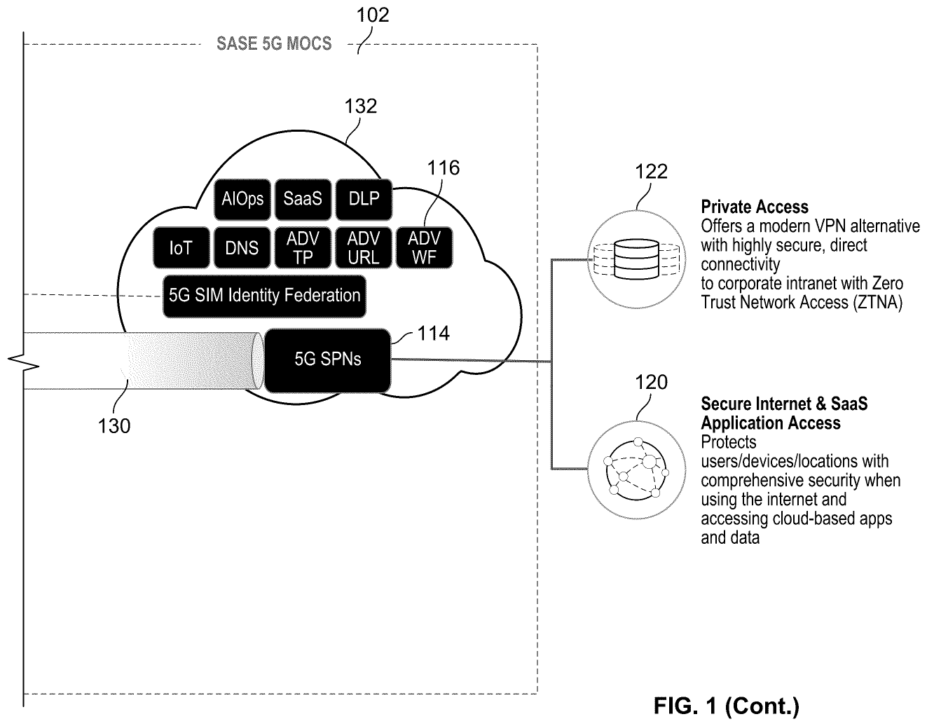

For example, the SASE cloud network can include a FWaaS that is configured with a plurality of security policies based on a subscriber identity, a unique device identifier, and an application identifier, in which the subscriber identity includes an IMSI (and/or MSISDN), and the unique device identifier includes an IMEI. The mobile core network can include a 4G mobile core network, a 5G mobile core network, and/or 6G mobile core network (e.g., or later generation mobile core network). The data plane traffic is secured from and to 4G, 5G, and/or 6G UE devices. The Internet access (e.g., secure Internet and SaaS Application Access, such as shown at 120 in FIG. 1, and similarly Private Access for secure, direct connectivity to corporate Intranet with Zero Trust Network Access (ZTNA) as shown at 122 in FIG. 1) is secured from and to 4G, 5G, and/or 6G UE devices. The enterprise data center access (e.g., for a tenant of the SASE solution) is secured from and to 4G, 5G, and/or 6G UE devices. The selection and the enforcement of the security policy is based on the contextual information associated with the UE and the data plane traffic correlated with the UE based on a UE Internet Protocol (IP) address.

Various security use cases can be addressed using the disclosed techniques for multi-operator core SASE solutions (e.g., for 5G SASE) including one or more of the following: (1) a FWaaS associated with the SASE is configured to perform Uniform Resource Link (URL) filtering for the data plane traffic; (2) a FWaaS associated with the SASE is configured to perform application Denial of Service (DoS) detection for the data plane traffic; and (3) a FWaaS associated with the SASE is configured to perform application Denial of Service (DoS) prevention for the data plane traffic.

In an example implementation, each of a plurality of security policies is distinctly selected and enforced for each mobile service provider (MSP) enterprise tenant at the SASE cloud network, in which per tenant security policy configuration and enforcement are provided by the SASE cloud network.

In an example implementation, the data plane traffic is encapsulated with meta information, including a subscriber identity and/or a unique device identifier.

In some embodiments, a system, a process, and/or a computer program product for multi-operator core SASE solutions (e.g., for 5G SASE) further includes determining the security policy to apply at the SASE cloud network to the data plane traffic based on a subscriber identity and/or a unique device identifier.

Specifically, SASE (e.g., using a FWaaS entity) can be configured to process mobile network traffic received over the interconnect (e.g., the service provider interconnect can be provided using a roaming network provider) from the various service provider core mobile networks (e.g., independent of any particular mobile core network protocols; as control plane signaling can be provided, for example, via RADIUS, Diameter, or service provider API gateway services, such as further described herein) to extract contextual information, which can include User Equipment (UE) IP, IMSI/SUPI (e.g., Subscriber-ID), MSISDN, IMEI/PEI, S-NSSAI, APN/DNN, S-NSSAI, RAT Type information, IP to mobile subscriber traffic mappings, and/or other context-based information. The security platform can be further configured to apply a security policy (e.g., enforce one or more security rules) based on the contextual information.

The disclosed techniques for multi-operator core SASE solutions (e.g., for 5G SASE) facilitate a cloud native SASE stack and interconnect with a plurality of core mobile networks (e.g., a 4G/5G/6G/later mobile network core environment for a plurality of mobile network service providers).

Also, the disclosed techniques for multi-operator core SASE solutions (e.g., for 5G SASE) facilitate an agentless solution (e.g., an agent is not required to be deployed on the UEs/IoT devices (e.g., 4G/5G/6G devices)).

In addition, the disclosed techniques for multi-operator core SASE solutions (e.g., for 5G SASE) facilitate context-based security for mobile devices/users without requiring additional security equipment or security software/entities within the core mobile network (e.g., 5G packet core network of the mobile service providers).

As such, the disclosed techniques for multi-operator core SASE solutions (e.g., for 5G SASE) facilitate a SASE-based solution for mobile network environments (e.g., macro 5G, private 5G, and/or hybrid environments) with consistent zero trust policies (e.g., based on IMSI/IMEI, MSISDN, and/or other context information).

For example, the disclosed techniques for multi-operator core SASE solutions (e.g., for 5G SASE) can facilitate applying intelligent security for zero trust for mobile networks (e.g., based on an extracted Subscriber-ID and/or other contextual information) using a SASE environment in communication with a plurality of core mobile networks of distinct mobile service providers via the cloud-to-cloud interconnect (e.g., the service provider interconnect can be provided using a roaming network provider), such as further described below.

As yet another example, the disclosed techniques for multi-operator core SASE solutions (e.g., for 5G SASE) can facilitate applying intelligent security for zero trust for mobile networks including providing 5G subscriber/user and/or 5G equipment/device level known and unknown threat identification and prevention for 5G mobile network environments.

As yet a further example, the disclosed techniques for multi-operator core SASE solutions (e.g., for 5G SASE) can facilitate applying intelligent security for zero trust for mobile networks including providing 5G subscriber/user and/or 5G equipment/device level application security for 5G mobile network environments.

As a final example, the disclosed techniques for multi-operator core SASE solutions (e.g., for 5G SASE) can facilitate applying intelligent security for zero trust for mobile networks providing 5G subscriber/user and/or 5G equipment/device level URL filtering for 5G mobile network environments.

Moreover, service providers and enterprises can utilize the disclosed techniques for applying security for zero trust in mobile networks using a SASE solution to apply subscriber-ID based security over IP-based external network (e.g., similar to the Internet) perimeters.

Accordingly, new and improved security solutions that facilitate applying security (e.g., network-based security) for zero trust in a 5G Service Access Service Edge (SASE) environment (e.g., the security platform can be implemented using a firewall (FW)/Next Generation Firewall (NGFW), FWaaS, a network sensor acting on behalf of the firewall, or another (virtual) device/component that can implement security policies using the disclosed techniques, including, for example, Palo Alto Networks' Prisma Access Secure Service Edge (SSE), Palo Alto Networks' PA Series next generation firewalls, Palo Alto Networks' VM Series virtualized next generation firewalls, and CN Series container next generation firewalls, and/or other commercially available virtual-based or container-based firewalls can similarly be implemented and configured to perform the disclosed techniques) (e.g., a 5G/later versions of mobile networks), and in some cases, on various interfaces (e.g., N6, etc.) and protocols (e.g., PFCP, RADIUS, Diameter, etc.) in mobile network environments are disclosed in accordance with some embodiments.

As such, new and improved techniques for providing multi-operator core SASE solutions for 5G SASE will now be further described below.

### Example System Architectures for Providing Multi-Operator Core SASE Solutions for 5G SASE

Accordingly, in some embodiments, the disclosed techniques for SASE for mobile networks (e.g., such as for applying intelligent security for zero trust in mobile networks) can be provided using security platforms (e.g., the security function(s)/platform(s) can be implemented using Palo Alto Networks' Prisma Access Secure Service Edge (SSE), a firewall (FW)/Next Generation Firewall (NGFW), a network sensor acting on behalf of the firewall, or another (virtual) device/component that can implement a firewall as a service entity for enforcing one or more security policies using the disclosed techniques, such as PANOS executing on a virtual/physical NGFW solution commercially available from Palo Alto Networks, Inc. or another security platform/NFGW, including, for example, Palo Alto Networks' PA Series next generation firewalls, Palo Alto Networks' VM Series virtualized next generation firewalls, and CN Series container next generation firewalls, and/or other commercially available virtual-based or container-based firewalls can similarly be implemented and configured to perform the disclosed techniques, including using SD-WAN devices and/or clusters executing firewall as a service entities) are configured to provide deep packet inspection (DPI) capabilities (e.g., including stateful inspection) of, for example, user/subscriber sessions (e.g., user/subscriber traffic) provided to the SASE solution via an interconnect (e.g., a cloud-to-cloud interconnect, such as from a Google Cloud Platform (GCP) cloud-based environment for the service provider's core mobile network in to a SASE cloud-based environment) to apply security on traffic in mobile networks based on a policy (e.g., layer-7 security and/or other security policy enforcement) as further described below.

Specifically, as will now be described with respect to various system embodiments, context-based security can be applied to mobile device related traffic (e.g., 4G/5G/6G/later related mobile network traffic) using a SASE solution, such as will be further described below with respect to various embodiments. In an example implementation, context-based security can be applied using SASE to such traffic passing thru mobile networks based on one or more of the following: a subscriber/user including IMSI, IMEI, MSISDN, RAT type, Network Slice, DNN/APN, location, user IP, and/or other contextual information.

More specifically, the disclosed techniques for a SASE solution (e.g., a Prisma SASE 5G solution) facilitate a 5G SASE Multi-Operator Core SASE (MOCS) based solution to effectively and efficiently provide a Zero Trust Security service/solution across a large number of mobile operators.

For example, the disclosed 5G SASE MOCS service/solution provides for seamless support for multiple 5G operator SIMs and 5G operators to provide complete coverage to all 5G devices in a given enterprise (e.g., tenant of the 5G SASE MOCS service/solution).

As another example, the disclosed 5G SASE MOCS service/solution can enable and govern security policies based on multiple operators' 5G SIM identities per tenant.

As yet another example, the disclosed 5G SASE MOCS service/solution can establish a service provider interconnect (SPI) with the SP Gateway rather than with each service provider/carrier network.

As a further example, the disclosed 5G SASE MOCS service/solution can differentiate policies based on per mobile network operator's network-based controls (e.g., access point network (APN), 5G Slice-IDs, etc.) and on a per tenant/customer, per 5G user/device (e.g., SIM, IMSI, IMEI, MSISDN, etc.) or per 5G user group.

FIG. 1 is a system diagram of an architecture for providing multi-operator core SASE solutions for 5G SASE in accordance with some embodiments.

Specifically, FIG. 1 illustrates an example system embodiment for providing multi-operator core Secure Access Service Edge (SASE) solutions for 5G SASE, shown as SASE 5G MOCS 102, using a service provider (SP) interconnect 130. SASE generally refers to a cloud-based architecture that combines network and security functions into a single service. SASE delivers these services directly to the source of connection, rather than through a data center. Various commercially available SASE solutions are provided by security vendors, including, for example, Palo Alto Networks, Inc., headquartered in Santa Clara, CA, which provides a commercially available SASE solution referred to as PRISMA® SASE.

More specifically, the disclosed techniques provide effective solutions for the above-described security and technical challenges by providing a SASE service/solution for enterprises that utilize multiple different mobile network service providers. The disclosed techniques for providing multi-operator core SASE solutions for 5G SASE using a roaming network provider 112 (e.g., shown as SP roaming & peering network) and SP interconnect solution to provide seamless security for 5G/mobile network data traffic from a plurality of distinct mobile network service providers will be further described below.

Specifically, FIG. 1 illustrates an example architecture for interconnecting a plurality of 5G mobile networks, including 5G Network Operator 1 110A, 5G Network Operator 2 110B, and 5G Network Operator n 110C, with a SASE cloud-based environment 132 (e.g., which can be provided using a Prisma SASE hyperscaler cloud-based solution in this example, which is a commercially available SASE solution from Palo Alto Networks, Inc., headquartered in Santa Clara, CA, and/or other available SASE solution can similarly be used).

More specifically, the plurality of 5G mobile networks 110A, 110B, and 110C are in secure communication with the SASE cloud-based environment 132 using a roaming network provider 112 (e.g., such as a Service Provider (SP) roaming & peering network or a mobile operator core network (MOCN) roaming & peering network), a Service Provider (SP) Gateway (e.g., such as commercially available from Emnify or Celona or other service providers) 124 that includes a 5G Authentication (Auth) Proxy component 126 (e.g., a 3GPP compliant auth proxy) and a 5G User Plane component 128 (e.g., a Gateway GPRS (General Packet Radio Services) Support Node (GGSN) or Packet Gateway (PGW)), and SP Interconnect 130 (e.g., a cloud-to-cloud interconnect).

In an example implementation, a partner is selected to provide the SP roaming and peering network service and SP gateway (e.g., preferably a partner that has established mobile network service provider/carrier relationships and can support connectivity with major mobile network service provider/carrier 5G networks across the world (or relevant geographies for the SASE service and their enterprise customers/tenants)) with the SP network (e.g., and supports mobile network service provider/carrier SIMs and E-SIMs or offers their own SIMS and E-SIMs).

In an example implementation, (1) the SP Gateway provides Authentication and Authorization signals (IMSI, IMEI, MSISDN, UE IP Address on a per mobile network service provider/carrier basis) to the SASE service; (2) the SP Gateway establishes cloud-to-cloud connectivity with Prisma SASE 5G for 5G User Plane traffic (1280 over SP Interconnect (130)); and (3) the SP Gateway partitions traffic from each mobile network service provider/carrier to Prisma SASE 5G (ideally supports geneve headers in IP packets).

In an example implementation, a Google Cloud Platform (GCP) Partner interconnect, such as shown as SP Interconnect (SPI) 130, can be used to connect the plurality of 5G mobile networks 110A-C via SP Roaming & Peering Network 112 and SP Gateway 124 with the Prisma SASE cloud 132 (e.g., or for other available cloud-based computing environments, such as Amazon Web Services (AWS), Microsoft Azure, etc., and other cloud-based interconnects provided for those cloud-based computing environments can similarly be used). Specifically, the GCP Partner Interconnect connection (e.g., as shown at 130 in FIG. 1) can be used for securely passing traffic between these cloud-based network environments of SP mobile networks 110A, 110B, 110C and SASE 132.

Referring to SASE cloud 132, 5G Security Processing Nodes (SPNs) (e.g., 5G SPN clusters) as shown at 114 in FIG. 1 provide firewall entities, specifically, firewalls as a service (FWaaS), for implementing the disclosed enhanced, context-based security for mobile devices connecting to the plurality of 5G mobile networks 110A-C (e.g., the security function(s)/platform(s) can be implemented using a firewall (FW)/Next Generation Firewall (NGFW), a network sensor acting on behalf of the firewall, or another (virtual) device/component that can implement security policies using the disclosed techniques, including, for example, Palo Alto Networks' PA Series next generation firewalls, Palo Alto Networks' VM Series virtualized next generation firewalls, and CN Series container next generation firewalls, and/or other commercially available virtual-based or container-based firewalls can similarly be implemented and configured to perform the disclosed techniques via these firewall as a service entities) as further described below.

As referred to herein, IMSI is the concept referred to by ITU-T as the “International Mobile Subscription Identity.” IMSI is a 14 or 15 digit number.

As also referred to herein, SUPI is a globally unique 5G “Subscription Permanent Identifier” allocated to each subscriber in the 5G system. As per 3GPP T.S 23.003 version 16.9.0, a SUPI type may indicate an IMSI, a network access identifier (NAI), a Global Line Identifier (GLI), or a Global Cable Identifier (GCI).

As also referred to herein, International Mobile Equipment Identifier (IMEI) is defined in 3GPP TS 23.003 available at https://portal.3gpp.org/desktopmodules/Specifications/SpecificationDetails.aspx?specificationId=729.

Referring to FIG. 1, below are example stages of processing for providing multi-operator core SASE solutions for 5G SASE in this example implementation. In this example environment, 5G SIM Devices from Operator 1 (e.g., UEs including IoT devices) 104A and an SD-WAN (e.g., Prisma® SD-WAN) 106A are shown in communication with a mobile service provider's mobile packet core network for 5G Network Operator 1 110A via 5G RAN 108A. Similarly, 5G SIM Devices from Operator 2 (e.g., UEs including IoT devices) 104B and an SD-WAN (e.g., Prisma® SD-WAN) 106B are shown in communication with a mobile service provider's mobile packet core network for 5G Network Operator 2 110B via 5G RAN 108B, and 5G SIM Devices from Operator 3 (e.g., UEs including IoT devices) 104C and an SD-WAN (e.g., Prisma® SD-WAN) 106C are shown in communication with a mobile service provider's mobile packet core network for 5G Network Operator 3 110C via 5G RAN 108C.

In another example implementation, if 5G RAN sharing is deployed implemented using, for example, OPEN-RAN, then the disclosed techniques can be similarly implemented as similarly described herein to support a multi-operator core network deployment using a Service Provider Gateway 124 and Service Provider Interconnect 130 to the SASE cloud network 132.

At a first stage, a mobile service provider (e.g., a SASE admin, such as an AT&T Mobile SASE admin for an AT&T Mobile 5G network, a T-Mobile SASE admin for a T-Mobile 5G network, or a Verizon SASE admin for a Verizon 5G network) configures IMSI, MSISDN, IMEI, APN, and/or other parameters associated with 5G mobile network traffic in the SASE provided Managed Service Provider (MSP) portal (e.g., using the portal in the Prisma Access SASE solution, which provides a platform to configure IMSI, MSISDN, IMEI, APN, etc. to identify UEs from each mobile service provider) under a managed service provider and configures respective security policies per user group/individual users, and to activate the 5G tenant root such that the enterprise tenants for 5G are instantiated. Also, the IMSI, MSISDN, IMEI, APN, and/or other mobile identifier related values can be similarly configured as described above and assigned to respective tenants.

At a second stage, the SP roaming & peering network service provider activates a partner interconnect/direct connect for each of the plurality of 5G mobile networks 110A-C with the SASE cloud-based environment 132. For example, an interconnect can be activated to the SASE solution as similarly described above with respect to FIG. 1 using SP Roaming & Peering Network 112 and SP Gateway 124 (e.g., each provided by the SP roaming & peering network service provider) and SP Interconnect 130 (e.g., using a cloud-to-cloud interconnect, such as from a Google Cloud Platform (GCP) cloud-based environment for the service provider's core mobile network into a SASE cloud-based environment, or another similar interconnect solution can similarly be provided) to apply security on traffic in mobile networks based on a policy (e.g., layer-7 security and/or other security policy enforcement) as further described below. Further, the interconnect can be configured with dedicated bandwidth on each packet core edge location to facilitate efficient network performance. As such, in this example implementation, the SP interconnect is established with the SP Gateway rather than with each telco's/server provider's mobile core network.

At a third stage, an IMSI feed and tenant meta data are received at a SASE RADIUS service (not shown in FIG. 1). In this example implementation, a RADIUS stream from each of the plurality of mobile service providers (e.g., AT&T, T-Mobile, Verizon, etc.) with authentication (auth) tokens/certifications (certs) is received at the SASE RADIUS service. The SASE RADIUS service then extracts the associated IP address and IMSI from the RADIUS stream. As such, the SASE RADIUS service facilitates receiving and adding a mapping identifier to the IP mapping, such as further described below.

At a fourth stage, leveraging partner/direction to the SASE cloud, all the data path traffic and RADIUS messages are routed to the SASE service provider's endpoint using the SP Interconnect (SPI) 130 (e.g., or directly via the Internet or via the RadSec protocol over TCP or TLS protocols).

At a fifth stage, the mobile service provider's packet core is configured with the next hop 5G secure endpoint to ensure that the source IP address should be the end client IP address. For example, the mobile service provider network router can be configured with the next hop as the IP address for the SP Gateway 124 with NATTED UE client IP address. When the SP Gateway 124 receives traffic and forwards the traffic to SASE 132 via SP Interconnect 130, the source IP address can be extracted as the actual mobile user client IP address and the destination as the actual destination IP address (e.g., similar to if the UE user attempted to reach a website, such as example.com, etc.).

At a sixth stage, the SASE service processes the RADIUS start message and populates the 5G sync data with 5G user identity (e.g., IMSI and/or MSISDN information), IP mappings, and tenant meta data in SASE edge devices in the SASE cloud-based network environment 132 using a 5G synchronized service (e.g., not shown in FIG. 1).

At a seventh stage, data plane traffic (e.g., 5G User Plane traffic 128) is sent from the mobile service provider packet core (e.g., 110A, 110B, and/or 110C) to the SASE cloud-based network environment 132 via the SPI 130. In this example implementation, the proxy layer (e.g., 5G Auth Proxy 126) facilitates receiving an allow IP list mapping to the tenant identifier and forwarding the traffic to the SASE cloud-based environment 132.

At an eighth stage, a cloud-delivered security services (CDSS) check is optionally performed. In an example implementation, a Gatekeeper is used for performing an Application (APP) URL check and DNS resolution with cloud-delivered security services (CDSS) (e.g., providing a verdict of pass or fail).

At a ninth stage, the IP address is passed and a tenant verdict is determined using the assigned to a respective Enterprise tenant's security processing node (SPN) (e.g., FWaaS) for the security processing in the SASE cloud-based environment as shown at 114. In this example implementation, once the 5G data plane traffic is received on the SPI 130, the flow is assigned to an Enterprise tenant's SPN (e.g., performing deep packet inspection (DPI) of the data plane traffic, such as to provide layer-7 security processing) for automatically detecting an IP authorized (auth) list allow/deny, and for a flow in the allow list, verifying the URL category and DNS security are automatically performed as a first level verdict.

In some embodiments, the 5G SPN entities/clusters (e.g., firewall as a service (FWaaS)) are configured to provide the following example DPI capabilities: DPI of Packet Forwarding Control Protocol (PFCP) traffic and/or other protocol formatted network traffic received via, for example, the SP Interconnect 130. In an example implementation, the firewall as a service entities are configured to provide DPI capabilities (e.g., including to identify a UE IP, IMSI/SUPI, MSISDN, IMEI/PEI, S-NSSAI, APN/DNN, and/or RAT Type information, application (App) ID, etc.) of, for example, PFCP messages that pass through, for example, the N6 and/or other interfaces between UPF and other 5G core mobile network entities within the core mobile network environment to apply context-based security traffic based on a policy (e.g., layer-7 security and/or other security policy enforcement).

In one embodiment, the disclosed techniques for providing multi-operator core SASE solutions for 5G SASE rely on the 5G packet core mobile network for interpreting the PFCP messages and sending the summarized information (e.g., including various associated contextual information as described herein) via a communication mechanism (e.g., RADIUS accounting messages, DIAMETER messages, and/or another protocol can be similarly used, and/or an API communication mechanism can be similarly used) to the 5G SASE solution.

In another embodiment, the security platform is configured to utilize DPI to extract various contextual information from monitored 5G packet core mobile network protocols, which can include, for example, removing the entry of a UE IP and related contextual information from the database if either of the following messages occur based on the monitoring of the PFCP protocol: (1) a PFCP session deletion request/response message to delete the PFCP control session; and (2) user/subscriber session(s) timeout message (e.g., such timeouts can be configurable). More specifically, in this example implementation in which the security platform is configured to utilize DPI to extract various contextual information from monitored 5G packet core mobile network protocols, the firewall as a service entities provided via 5G SPN clusters 114 are configured to monitor PFCP messages including the following: (1) a PFCP Session Establishment Procedure (e.g., as per 3GPP T.S 29.244 v 18.3.0 (e.g., which is publicly available at https://portal.3gpp.org/desktopmodules/Specifications/SpecificationDetails.aspx?specificationId=3111), a PFCP Session Establishment procedure shall be used to set up a PFCP session between a CP function and a UP function and configure Rules in the UP function so that the UP function can handle incoming packets); (2) a PFCP Session Modification Procedure (e.g., the PFCP Session Modification procedure shall be used to modify an existing PFCP session, e.g., to configure a new rule, to modify an existing rule, to delete an existing rule); and (3) a PFCP Session Deletion Procedure (e.g., the PFCP Session Deletion procedure shall be used to delete an existing PFCP session between the CP function and the UP function) to facilitate extraction of the above-described contextual information.

In this example implementation, the firewall as a service entities provided via 5G SPN entities/clusters (114) are configured to provide various enhanced, context-based security based on the monitored user plane data traffic flows received via the Interconnect at the mapped firewall as a service entity/ies (e.g., to set up the flow information for each new UE connection to the 5G core mobile network). The data traffic flows (e.g., sessions) can be correlated based on the source IP address for the data traffic flows the relevant UE IP received and stored above to associate such data traffic flows to the relevant context information associated with the UE IP. The firewall as a service entity/ies can then select and apply a security policy to each data traffic flow using the relevant contextual information for each such data traffic flow.

As such, the disclosed techniques for providing multi-operator core SASE solutions for 5G SASE facilitate a cloud native SASE stack with SIM-based authentication, federation, and interconnect with core mobile networks (e.g., a 4G/5G/6G/later mobile network core environment).

In this example implementation, the FWaaS entities provided via 5G SPN entities/clusters (114) are configured to provide various SASE related services, including for example Artificial Intelligence powered Operations (AIOps), Software as a Service (SaaS) secure and high-speed connections (e.g., for SalesForce, Microsoft Office 365, and/or other SaaS solutions), Data Loss Prevention (DLP) security, IoT security, Domain Name System (DNS) security, Advanced Threat Protection (ATP) security, Advanced Uniform Resource Link (URL) security, and/or other SASE/security related services.

In addition, the firewall as a service entities provided via 5G SPN entities/clusters can also be in network communication with a Cloud Security Service (not shown) (e.g., a commercially available cloud-based security service, such as the WildFire™ (ADV WF) cloud-based malware analysis environment (116) that is a commercially available cloud security service provided by Palo Alto Networks, Inc., which includes automated security analysis of malware samples as well as security expert analysis, or a similar solution provided by another vendor can be utilized), such as via the Internet. For example, a Cloud Security Service can be utilized to provide the security platforms with dynamic prevention signatures for malware, DNS, URLs, CNC malware, and/or other malware as well as to receive malware samples for further security analysis.

At a tenth/final stage, the assigned Enterprise tenant's SPN receives the data plane traffic for security processing, automatically applies a relevant security policy (e.g., the security policy can be defined per enterprise tenant), and then sends the traffic, if allowed, based on the SPN processing using the security policy, to the remote endpoint (EP), such as egressing traffic to an Internet access, a Software as a Service (SaaS) app, and/or a private application (app) (e.g., a private Enterprise app, etc.). If the policy determines that the traffic is not allowed based on the SPN processing using the security policy, then the traffic can be blocked, dropped, and/or another action can similarly be performed based on the policy (e.g., quarantining, logging, etc.). As such, per tenant level security policies can be configured using the cloud-based SASE environment.

As such, the disclosed techniques provide a solution for providing multi-operator core SASE solutions for 5G SASE, which is more secure with direct connection and low latency.

Also, the disclosed techniques facilitate providing zero trust security for mobile devices for enterprises that utilize a plurality of different mobile network service providers. For example, the disclosed techniques provide seamless support for multiple 5G operator SIMs and 5G operators (e.g., mobile network service providers) to provide complete coverage to all 5G devices in an enterprise.

Also, the disclosed techniques can be implemented to enable and govern security policies based on multiple operators' 5G SIM identities per SASE tenant, such as similarly described above with respect to FIG. 1.

In addition, the disclosed techniques can differentiate policies based on per operator's network-based controls (e.g., APN or 5G Slice-IDs, etc.) and on a per customer, per 5G user/device (e.g., SIM, IMSI, MSISDN, IMEI, etc.) or per 5G user group, such as similarly described above with respect to FIG. 1.

Moreover, the disclosed techniques for a SASE 5G MOCS as shown in FIG. 1 extend 5G to non-5G devices with 5G capable MOCS SASE SD-WAN (e.g., Prisma® SD-WAN) for Wi-Fi and non-5G devices.

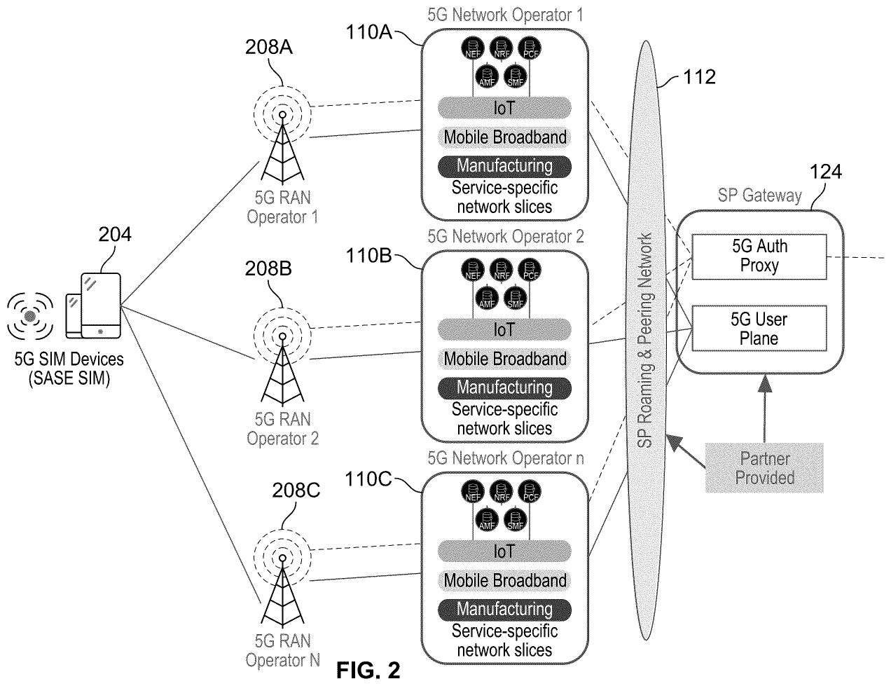

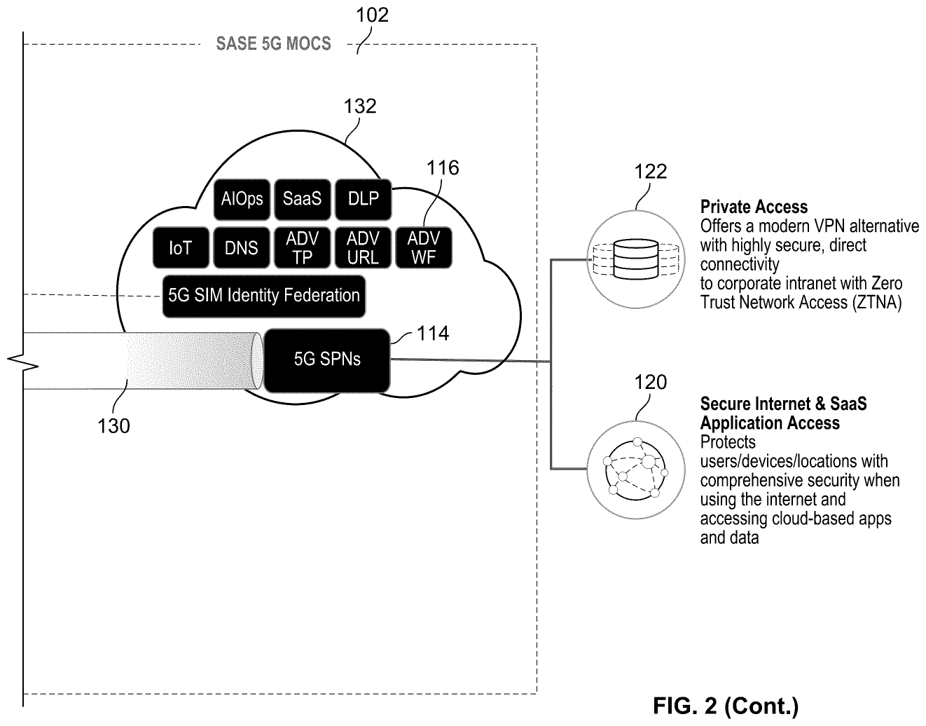

FIG. 2 is another system diagram of an architecture for providing multi-operator core SASE solutions for 5G SASE in accordance with some embodiments.

FIG. 2 illustrates a similar architecture for a SASE 5G MOCS 102 as shown in FIG. 1 except in this example architecture the SASE provider facilitates support for a single SASE SIM to connect to multiple 5G operators/mobile network service providers to provide complete coverage to all 5G devices in an enterprise/tenant of the SASE service, such as shown at 5G SIM devices (SASE SIM) 204 and 5G RAN Operators 1, 2, 3 as shown at 208A, 208B, and 208C, respectively.

Thus, the disclosed techniques as shown in FIG. 2 provide seamless support for a single SASE SIM (e.g., on Prisma SD-WAN appliances) to connect to multiple 5G operators/mobile network service providers.

Also, the disclosed techniques as shown in FIG. 2 facilitate complete coverage to all non-5G devices in an enterprise.

In addition, the disclosed techniques as shown in FIG. 2 can enable and govern SD-WAN path policy and routing decisions based on multiple operators.

Further, the disclosed techniques as shown in FIG. 2 facilitate enterprise admin control policies based on and on per operator, per region, per SD-WAN branch for non-5G user/devices connected on the LAN (e.g., IP, Mac-address, Device ID, Enterprise/Tenant ID, etc.) or per enterprise/tenant user group.

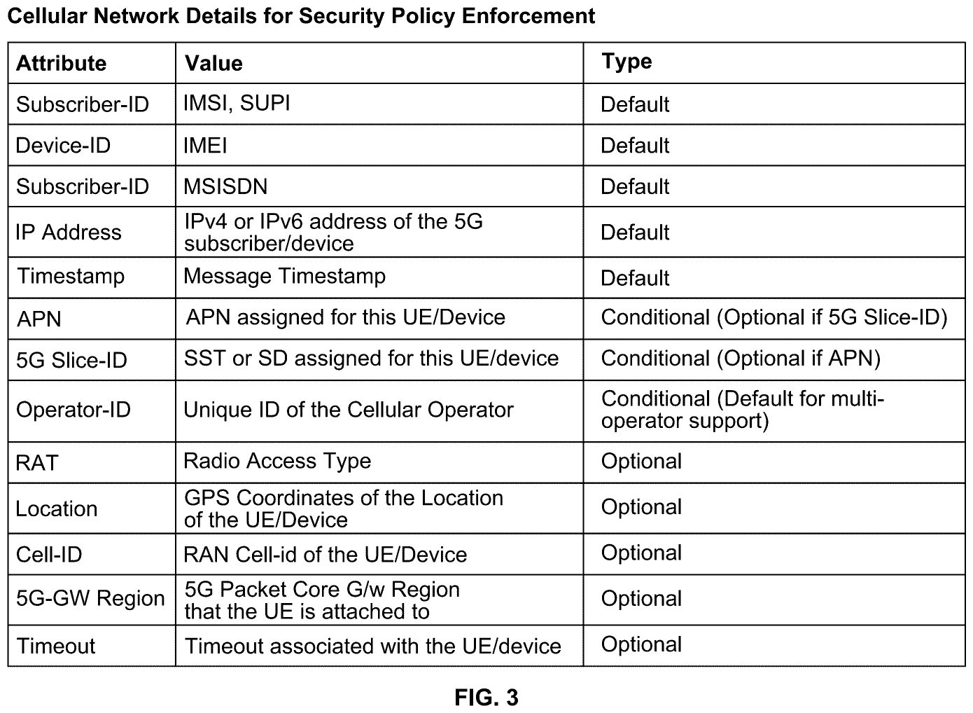

FIG. 3 is an example table for cellular network details for security policy enforcement for providing multi-operator core SASE solutions for 5G SASE in accordance with some embodiments. As shown in this example table, certain cellular related attributes are used by default for security policy enforcement, others are conditional, in which APN or network/5G Slice-ID can be used, and Operator-ID is generally used by default for multi-operator support.

As such, the disclosed techniques for a SASE 5G MOCS provide comprehensive visibility into 5G users and devices in enterprises/tenants of the SASE service.

Also, the disclosed techniques for a SASE 5G MOCS enable and govern security policies based on each operator's/telco's/mobile network service provider's own 5G SIM identities.

In addition, the disclosed techniques for a SASE 5G MOCS can be applied to differentiate policies based on network-based controls (e.g., APN or Network/5G Slice-IDs, etc.) and on a per customer, per 5G user/device (e.g., SIM, IMSI, MSISDN, IMEI, etc.), or per cellular/5G user group.

Finally, the disclosed techniques for a SASE 5G MOCS can be implemented to guarantee Quality of Service (QoS) and quality of experience (QoE) based on cellular/5G network parameters while delivering best-in-class security for the enterprise/tenant.

Accordingly, the above-described techniques and various embodiments for providing multi-operator core SASE solutions for 5G SASE can be applied to provide one or more of the following: (1) secure data traffic flow (e.g., private app access, SaaS app access, other apps/services, etc.) from and to 4G/5G/6G/later devices; (2) secure Internet access from 4G/5G/6G/later UEs; (3) secure access to enterprise data center from 4G/5G/6G/later UEs; (4) enforcement of UE (user) specific security policies (e.g., based on UE IP, IMSI, MSISDN, IMEI, location, APN/DNN, network slice, RAT, and/or other contextual information); and (5) separation of security policies for each tenant (e.g., automatically detecting each MSP Enterprise tenant (tenant ID) associated with each data packet passing through the SASE/security core network).

Additional example processes for the disclosed techniques for providing multi-operator core SASE solutions for 5G SASE will be further described below.

### Example Process Embodiments for Providing Multi-Operator Core SASE Solutions for 5G SASE

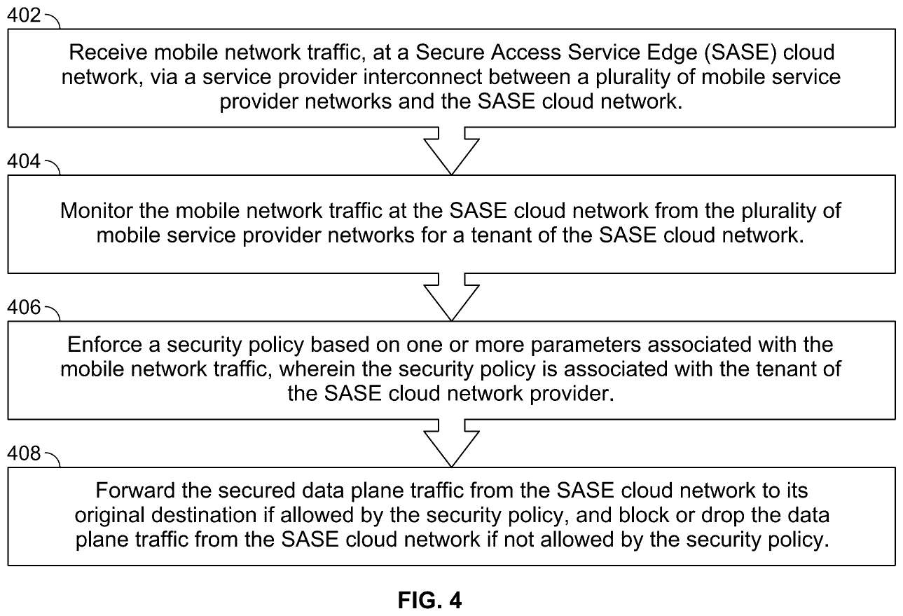

FIG. 4 is a flow diagram of a process for providing multi-operator core SASE solutions for 5G SASE in accordance with some embodiments. In some embodiments, a process as shown in FIG. 4 is performed by the SASE solution and techniques as similarly described above including the embodiments described above with respect to FIGS. 1-3. In one embodiment, the process shown in FIG. 4 is performed, at least in part, by 5G SPN entities/clusters as described above with respect to FIG. 1.

The process begins at 402. At 402, mobile network traffic (e.g., 5G user/data plane traffic) is received, at a SASE cloud network, via a service provider interconnect between a plurality of mobile service provider networks and the SASE cloud network. As similarly described above with respect to FIG. 1, a service provider (SP) interconnect (e.g., a GCP interconnect or other cloud to cloud interconnect) can be used for securely transmitting traffic from the mobile core network to the SASE cloud network. As also described above, the SP interconnect receives the mobile network traffic from the plurality of mobile service provider networks via an SP roaming and peering network and SP Gateway as similarly described above with respect to FIG. 1.

At 404, monitoring the mobile network traffic at the SASE cloud network from the plurality of mobile service provider networks for a tenant of the SASE cloud network is performed.

At 406, enforcing a security policy based on one or more parameters associated with the mobile network traffic is performed. For example, the security policy can be associated with the tenant of the SASE cloud network provider.

At 408, the secured user plane traffic (e.g., data plane traffic) is forwarded from the SASE cloud network to its original destination if allowed by the security policy, and the data plane traffic is blocked or dropped from the SASE cloud network if not allowed by the security policy. For example, various cellular attributes/parameters can be used for security policy enforcement, such as shown in the table of FIG. 3.

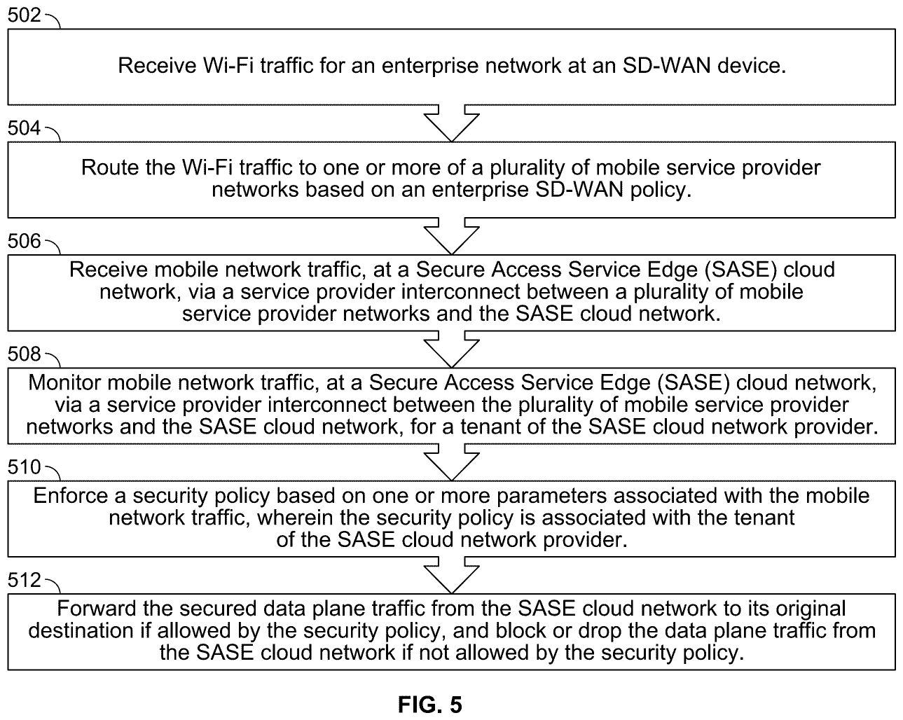

FIG. 5 is another flow diagram of a process for providing multi-operator core SASE solutions for 5G SASE in accordance with some embodiments. In some embodiments, a process as shown in FIG. 5 is performed by the SASE solution and techniques as similarly described above including the embodiments described above with respect to FIGS. 1-3. In one embodiment, the process shown in FIG. 5 is performed, at least in part, by 5G SPN entities/clusters as described above with respect to FIG. 1.

The process begins at 502. At 502, Wi-Fi traffic for an enterprise network is received, at an SD-WAN device. For example, the enterprise network can be associated with a tenant of the SASE provider (e.g., and the SD-WAN device can be associated with the SASE provider), such as similarly described above with respect to FIG. 1.

At 504, the Wi-Fi traffic is routed to one or more of a plurality of mobile service provider networks based on an enterprise SD-WAN policy.

At 506, mobile network traffic (e.g., 5G user/data plane traffic) is received, at a SASE cloud network, via a service provider interconnect between a plurality of mobile service provider networks and the SASE cloud network. As similarly described above with respect to FIG. 1, a service provider (SP) interconnect (e.g., a GCP interconnect or other cloud to cloud interconnect) can be used for securely transmitting traffic from the mobile core network to the SASE cloud network. As also described above, the SP interconnect receives the mobile network traffic from the plurality of mobile service provider networks via an SP roaming and peering network and SP Gateway as similarly described above with respect to FIG. 1.

At 508, monitoring the mobile network traffic is performed, at the SASE cloud network, via a service provider interconnect between the plurality of mobile service provider networks and the SASE cloud network, for a tenant of the SASE cloud network provider.

At 510, enforcing a security policy based on one or more parameters associated with the mobile network traffic is performed. For example, the security policy can be associated with the tenant of the SASE cloud network provider (e.g., and the enterprise network can be associated with the tenant of the SASE cloud network provider). For example, various cellular attributes/parameters can be used for security policy enforcement, such as shown in the table of FIG. 3.

At 512, the secured data plane traffic is forwarded from the SASE cloud network to its original destination if allowed by the security policy, and the data plane traffic is blocked or dropped from the SASE cloud network if not allowed by the security policy.

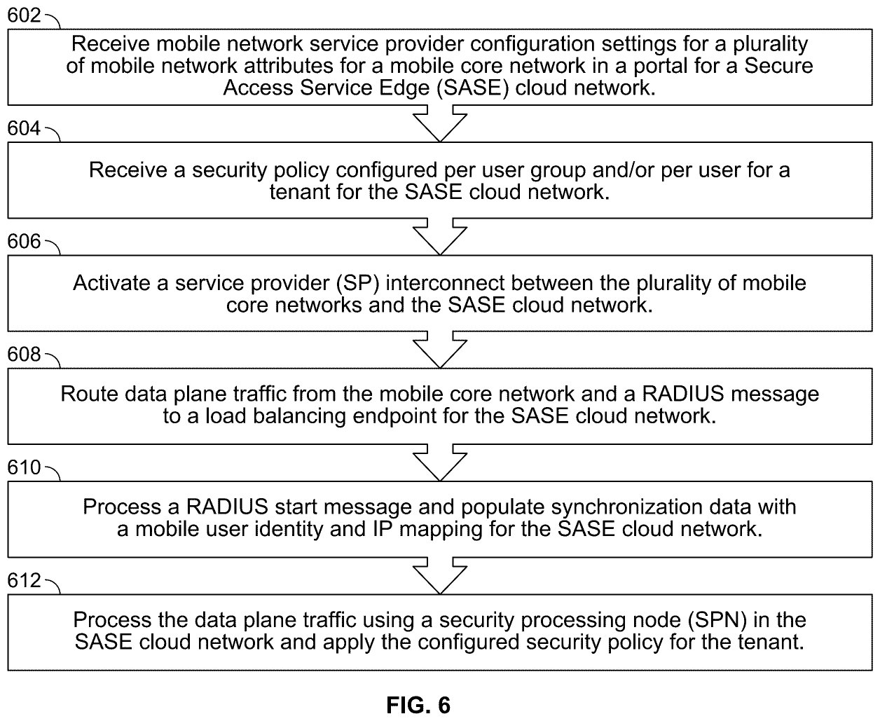

FIG. 6 is another flow diagram of a process for providing multi-operator core SASE solutions for 5G SASE in accordance with some embodiments. In some embodiments, a process as shown in FIG. 6 is performed by the SASE solution and techniques as similarly described above including the embodiments described above with respect to FIGS. 1-3. In one embodiment, the process shown in FIG. 6 is performed, at least in part, by 5G SPN entities/clusters as described above with respect to FIG. 1.

The process begins at 602. At 602, telco operator/mobile network service provider configuration settings are received for a plurality of mobile network attributes for a mobile core network in a portal for a Secure Access Service Edge (SASE) cloud network (e.g., and this can be performed for each of the service provider mobile core networks for each tenant of the SASE).

At 604, a security policy configured per user group and/or per user for a tenant for the SASE cloud network is received.

At 606, an SP interconnect (e.g., the SP interconnect as well as the SP roaming and peering network and gateway, such as similarly described above with respect to FIG. 1) between the plurality of mobile core networks and the SASE cloud network is activated.

At 608, data plane traffic (e.g., user plane traffic) and a RADIUS message are routed from the mobile core network to a load balancing endpoint for the SASE cloud network.

At 610, a RADIUS start message is processed and synchronization data is populated with a mobile user identity and IP mapping for the SASE cloud network. In some embodiments, other signaling messaging protocols can be used, for example, DIAMETER, application programming interfaces (APIs) (e.g., telecom APIs), and/or other signaling/messaging mechanisms.

At 612, the data plane traffic is processed using a security processing node (SPN) in the SASE cloud network and the configured security policy for the tenant is applied. For example, an action can be performed on the data plane traffic based on a verdict after applying the configured security policy for the tenant (e.g., the secured data plane traffic can be forwarded from the SASE cloud network to its original destination if allowed by the security policy, and the data plane traffic can be blocked or dropped from the SASE cloud network if not allowed by the security policy), such as similarly described above.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
receive mobile network traffic, at a Secure Access Service Edge (SASE) cloud network, via a service provider interconnect between a plurality of mobile service provider networks and the SASE cloud network;
monitor the mobile network traffic at the SASE cloud network from the plurality of mobile service provider networks for a tenant of a SASE cloud network provider;
enforce a security policy based on one or more parameters associated with the mobile network traffic, wherein the security policy is associated with the tenant of the SASE cloud network provider; and
forward secured data plane traffic from the SASE cloud network to its original destination if allowed by the security policy, and block or drop the secured data plane traffic from the SASE cloud network if not allowed by the security policy; and
a memory coupled to the processor and configured to provide the processor with instructions.

2. The system recited in claim 1, wherein the service provider interconnect between the plurality of mobile service provider networks and the SASE cloud network is provided using a roaming network provider.

3. The system recited in claim 1, wherein the SASE cloud network includes a firewall as a service (FWaaS) that is configured with distinct security policies for each of a plurality of tenants of the SASE cloud network provider, and wherein the security policy is selected based on a subscriber identity and an application identifier, and wherein the subscriber identity includes an International Mobile Subscriber Identity (IMSI).

4. The system recited in claim 1, wherein the SASE cloud network includes a firewall as a service (FWaaS) that is configured with distinct security policies for each of a plurality of tenants of the SASE cloud network provider, and wherein the security policy is selected based on a subscriber identity, a unique device identifier, and an application identifier, wherein the subscriber identity includes an International Mobile Subscriber Identity (IMSI) and/or Mobile Station International Subscriber Directory Number (MSISDN), and wherein the unique device identifier includes an International Mobile Equipment Identifier (IMEI).

5. The system recited in claim 1, wherein the mobile network traffic includes data plane traffic, and wherein the security policy is enforced on the data plane traffic associated with a UE based on contextual information associated with the UE to provide secured data plane traffic using the security policy configured per user group and/or per user associated with the tenant of the SASE cloud network provider.

6. The system recited in claim 1, wherein the mobile network traffic includes data plane traffic, and wherein the plurality of mobile service provider networks includes a 4G mobile core network, a 5G mobile core network, and/or 6G mobile core network, and wherein the data plane traffic from the plurality of mobile service provider networks is secured from and to 4G, 5G, and/or 6G UE devices.

7. The system recited in claim 1, wherein Internet access is secured from and to 4G, 5G, and/or 6G UE devices, and wherein enterprise data center access is secured from and to 4G, 5G, and/or 6G UE devices.

8. The system recited in claim 1, wherein the mobile network traffic includes data plane traffic, and wherein selection and the enforcement of the security policy is based on contextual information associated with a UE and the data plane traffic is correlated with the UE based on a UE Internet Protocol (IP) address.

9. The system recited in claim 1, wherein the mobile network traffic includes data plane traffic, and wherein a firewall as a service (FWaaS) associated with the SASE cloud network is configured to perform Uniform Resource Link (URL) filtering for the data plane traffic.

10. The system recited in claim 1, wherein the mobile network traffic includes data plane traffic, and wherein a firewall as a service (FWaaS) associated with the SASE cloud network is configured to perform application Denial of Service (DoS) detection for the data plane traffic.

11. The system recited in claim 1, wherein the mobile network traffic includes data plane traffic, and wherein a firewall as a service (FWaaS) associated with the SASE cloud network is configured to perform application Denial of Service (DoS) prevention for the data plane traffic.

12. The system recited in claim 1, wherein each of a plurality of security policies is distinctly selected and enforced for each mobile service provider (MSP) enterprise tenant at the SASE cloud network, wherein per tenant security policy configuration and enforcement are provided by the SASE cloud network.

13. The system recited in claim 1, wherein the mobile network traffic includes data plane traffic, and wherein the data plane traffic is encapsulated with meta information, including a subscriber identity and/or a unique device identifier.

14. The system recited in claim 1, wherein the mobile network traffic includes data plane traffic, and wherein the processor is further configured to:
determine the security policy to apply at the SASE cloud network to the data plane traffic based on a subscriber identity and/or a unique device identifier.

15. A method, comprising:
receiving mobile network traffic, at a Secure Access Service Edge (SASE) cloud network, via a service provider interconnect between a plurality of mobile service provider networks and the SASE cloud network;
monitoring the mobile network traffic at the SASE cloud network from the plurality of mobile service provider networks for a tenant of a SASE cloud network provider;
enforcing a security policy based on one or more parameters associated with the mobile network traffic, wherein the security policy is associated with the tenant of the SASE cloud network provider; and
forwarding secured data plane traffic from the SASE cloud network to its original destination if allowed by the security policy, and block or drop the secured data plane traffic from the SASE cloud network if not allowed by the security policy.

16. The method of claim 15, wherein the SASE cloud network includes a firewall as a service that is configured with distinct security policies for each of a plurality of tenants of the SASE cloud network provider, and wherein the security policy is selected based on a subscriber identity and an application identifier, and wherein the subscriber identity includes an International Mobile Subscriber Identity (IMSI).

17. The method of claim 15, wherein the SASE cloud network includes a firewall as a service (FWaaS) that is configured with distinct security policies for each of a plurality of tenants of the SASE cloud network provider, and wherein the security policy is selected based on a subscriber identity, a unique device identifier, and an application identifier, wherein the subscriber identity includes an International Mobile Subscriber Identity (IMSI) and/or Mobile Station International Subscriber Directory Number (MSISDN), and wherein the unique device identifier includes an International Mobile Equipment Identifier (IMEI).

18. A computer program product, the computer program product being embodied in a tangible computer readable storage medium and comprising computer instructions for:
receiving mobile network traffic, at a Secure Access Service Edge (SASE) cloud network, via a service provider interconnect between a plurality of mobile service provider networks and the SASE cloud network;
monitoring the mobile network traffic at the SASE cloud network from the plurality of mobile service provider networks for a tenant of a SASE cloud network provider;
enforcing a security policy based on one or more parameters associated with the mobile network traffic, wherein the security policy is associated with the tenant of the SASE cloud network provider; and
forwarding secured data plane traffic from the SASE cloud network to its original destination if allowed by the security policy, and block or drop the secured data plane traffic from the SASE cloud network if not allowed by the security policy.

19. The computer program product recited in claim 18, wherein the SASE cloud network includes a firewall as a service that is configured with distinct security policies for each of a plurality of tenants of the SASE cloud network provider, and wherein the security policy is selected based on a subscriber identity and an application identifier, and wherein the subscriber identity includes an International Mobile Subscriber Identity (IMSI).

20. The computer program product recited in claim 18, wherein the SASE cloud network includes a firewall as a service that is configured with distinct security policies for each of a plurality of tenants of the SASE cloud network provider, and wherein the security policy is selected based on a subscriber identity, a unique device identifier, and an application identifier, wherein the subscriber identity includes an International Mobile Subscriber Identity (IMSI) and/or Mobile Station International Subscriber Directory Number (MSISDN), and wherein the unique device identifier includes an International Mobile Equipment Identifier (IMEI).

21. A system, comprising:
a processor configured to:
receive, at an SD-WAN device, Wi-Fi traffic for an enterprise network;
route the Wi-Fi traffic to one or more of a plurality of mobile service provider networks based on an enterprise SD-WAN policy;
receive, at a Secure Access Service Edge (SASE) cloud network, mobile network traffic from the plurality of mobile service provider networks via a service provider interconnect;
monitor the mobile network traffic, at the SASE cloud network from the plurality of mobile service provider networks, for a tenant of a SASE cloud network provider;
enforce a security policy based on one or more parameters associated with the mobile network traffic, wherein the security policy is associated with the tenant of the SASE cloud network provider, and wherein the enterprise network is associated with the tenant of the SASE cloud network provider; and
forward secured data plane traffic from the SASE cloud network to its original destination if allowed by the security policy, and block or drop the secured data plane traffic from the SASE cloud network if not allowed by the security policy; and
a memory coupled to the processor and configured to provide the processor with instructions.
